(19) United States
(12) Patent Application Publication
(10) Pub. No.: US 2023/0123684 A1
(43) Pub. Date: Apr. 20, 2023

(54) Furnace system for controlling of individual temperature through selectively radiating of electromagnetic waves

(71) Applicant: JPS CO., LTD., Gimhae-si (KR)

(72) Inventor: Dong Hoon YEO, Gimhae-si (KR)

(21) Appl. No.: 17/529,133

(22) Filed: Nov. 17, 2021

(30) Foreign Application Priority Data
Oct. 19, 2021 (KR) 10-2021-0139586

(51) Int. Cl. F27B 14/20; F27B 14/06; F27D 11/12; H05B 6/64; H05B 6/80; B22D 2/00

(52) U.S. Cl. CPC F27B 14/20; F27B 14/06; F27D 11/12; H05B 6/6408; H05B 6/645; H05B 6/80; B22D 2/006; H05B 2206/044; F27D 2099/0028

(57) ABSTRACT

The furnace system for controlling of individual temperature through selectively radiating of electromagnetic waves according to the present invention comprises: a heating body unit for heating a melt to a predetermined temperature; a heating sensing unit for selectively measuring the internal temperature of the heating body unit to calculate predetermined temperature information; a heating cover unit that selectively covers the heating body unit to prevent a predetermined heat from being diffused to the outside so that the melt maintains a predetermined temperature; and a radiating unit receiving the predetermined temperature information from the heating sensing unit and selectively irradiating a predetermined electromagnetic wave so that the melt becomes the predetermined temperature.

### TECHNICAL FIELD

The present invention relates to a furnace system for controlling of individual temperature through selectively radiating of electromagnetic waves. More specifically, in order to produce a melt by heating the melting furnace, the present invention senses the internal temperature of the melting furnace and selectively irradiates a predetermined electromagnetic wave according to temperature information, and uniformly heats the melt.

### BACKGROUND

Casting is one of the most basic techniques of metal molding and is used to manufacture large quantities of the same shape. Casting is made by putting scrap, pig iron, ferrous alloy or non-ferrous metal raw material in a furnace, heating and melting it, pouring it into a mold of sand or metal, and cooling it. At this time, the type used for casting is called a mold, and the product made by casting is called a casting.

That is, the molten metal is poured into a mold made of the desired model, molded, and then the molten metal is solidified to become the same metal object as the model.

According to the analysis of the Korea Institute of Industrial Technology, the world's total casting production is 10.83 million tons as of 2012, and the proportion is cast iron 71.8% (72.44 million tons), cast steel 11.2% (11.3 million tons), non-ferrous castings 17.0% (17.1 million tons) is composed of Total casting production in 2012 was 10.83 million tons, an increase of 2.2% compared to 2011, and an increase of 6.0% compared to 2008. As of 2012, Korea's casting production was 2.44 million tons, the 8th largest in the world, and it occupies a 2.4% share in the global casting market. China, which is riding the rapid growth of the foundry industry, has risen to the top spot in the casting production sector after overtaking Korea in 2001. In 2012, it produced 42.5 million tons, occupying a 42.1% share of the global market. The combined share of the top five countries in casting production, such as China, the United States, India, Japan, and Germany, is 74.6%.

As an example of a related prior patent document, “ferrosilicon casting apparatus (Registration No. 10-1587280, hereinafter referred to as Patent Document 1)” exists.

In the case of the invention according to Patent Document 1, an object of the present invention is to provide a ferrosilicon casting apparatus capable of injecting most ferrosilicon into a steelmaking process. Patent Document 1 discloses a ferrosilicon casting apparatus for casting ferrosilicon used as a subsidiary material of a steelmaking process, comprising: a distributor for uniformly distributing molten ferrosilicon after being supplied through a hot water heater; a chain device that includes a front sprocket and a rear sprocket, and rotates in a ring-free track by a driving device; a plurality of mold sets that are continuously seated on the chain device and accommodate the molten ferrosilicon supplied through the distributor; a cooling device disposed on the upper surface of the chain device to cool the mold set and the ferrosilicon seated inside the mold set; and a drying device disposed on the lower surface of the chain device to cool the mold set before entering the distributor, wherein the ferrosilicon solidified inside the mold set is discharged from the entire sprocket.

As another example of a patent document, “ferrosilicon casting method (Registration No. 10-1563363, hereinafter referred to as Patent Document 2)” exists.

In the case of the invention according to Patent Document 2, an object of the invention is to provide a ferrosilicon casting method capable of injecting most of the ferrosilicon into a steelmaking process. In the invention of Patent Document 4, in the ferrosilicon casting method for casting ferrosilicon used as a subsidiary material of the steelmaking process, the molten ferrosilicon distributing step of distributing the molten ferrosilicon through a distributor through a separate melting furnace; The molten ferrosilicon distributed through the distributor is a molten ferrosilicon shape casting step of casting into a specific shape using a mold set that is continuously transferred; a ferrosilicon cooling step of cooling the ferrosilicon and the mold set through the cooling device; Casting ferrosilicon extraction step of extracting the solidified ferrosilicon from the mold set; A mold set cooling step of cooling the mold set from which the ferrosilicon is extracted through a cooling device; and a drying step of drying the mold set through a drying device for moisture and cooling of the mold set surface.

As another example of a patent document, there is “an apparatus for manufacturing a ferrosilicon wire rod and a manufacturing method thereof (Registration No. 10-1994111, hereinafter referred to as Patent Document 3).”

In the case of the invention according to Patent Document 3, an apparatus for manufacturing a ferrosilicon wire rod capable of manufacturing a ferrosilicon wire rod having a size and shape suitable for input to a steelmaking process and a method for manufacturing the same are disclosed. A ferrosilicon wire rod production apparatus according to Patent Document 2 includes: a distributor for discharging and dispensing molten ferrosilicon; a transfer unit mounted on the lower side of the distributor, and for transferring the molten ferrosilicon discharged and distributed from the distributor while casting it in the form of a wire; a cooling unit mounted on the conveying unit and cooling the molten ferrosilicon wire conveyed by the conveying unit; a separation unit for separating the ferrosilicon wire cooled by the cooling unit from the transfer unit; and a cutting unit for manufacturing ferrosilicon wire pieces by cutting the ferrosilicon wire separated by the separation unit.

As another example of the patent document, “Molten material injection apparatus, casting equipment and casting method using the same (Registration No. 10-1790001, hereinafter referred to as Patent Document 4)” exists.

In the case of the invention according to Patent Document 4, it relates to a melt injection apparatus, a casting equipment and a casting method using the same, the process of providing a main mold flux; the process of pouring molten steel into the mold; preparing a molten mold flux by melting the main mold flux, and injecting the molten mold flux onto the molten steel; the process of casting slabs; and a process of determining whether to add additives according to the casting state in the process of casting the cast slab, and may improve the quality and productivity of the slab.

Existing prior art only discloses a process in which molten ferro silicon or ferro manganese is directly introduced into the mold in a molten state, and it is necessary to improve the technical element so that the molten material flows uniformly to the mold.

In addition, there is also a need for a technical element for preventing cooling in the process of inputting a steelmaking auxiliary material such as ferro silicon or ferro manganese into the mold.

### PRIOR ARTS

### Patent Document

(Patent Document 1) Korean Patent No. 10-1587280
(Patent Document 2) Korean Patent No. 10-1563363
(Patent Document 3) Korean Patent No. 10-1994111
(Patent Document 4) Korean Patent No. 10-1790001

### SUMMARY OF THE INVENTION

The Furnace system for controlling of individual temperature through selectively radiating of electromagnetic waves according to the present invention has been devised to solve the conventional problems as described above, and presents the following problems to be solved.

First, a predetermined electromagnetic wave is irradiated into the inside of the melting furnace to heat the melt to a certain temperature or higher to melt it.

Second, the melt is uniformly melted inside the furnace, and the thermal loss of the furnace is minimized.

Third, by sensing the temperature inside the melting furnace, a predetermined electromagnetic wave is selectively irradiated according to the temperature information.

The problems to be solved of the present invention are not limited to those mentioned above, and other problems not mentioned will be clearly understood by those skilled in the art from the following description.

The furnace system for controlling of individual temperature through selectively radiating of electromagnetic waves according to the present invention has the following means for the purpose described above.

The furnace system for controlling of individual temperature through selectively radiating of electromagnetic waves according to the invention comprises: a heating body unit for heating melt to a predetermined temperature when the melt is added; a heating sensing unit provided in the heating body unit to selectively measure the internal temperature of the heating body unit to calculate a preset temperature information; a heating cover unit that selectively covers the heating body unit and prevent a predetermined heat from being diffused to the outside so that the melt maintains the predetermined temperature; and a radiating unit selectively provided to the heating cover unit, receiving the predetermined temperature information from the heating sensing unit, and selectively irradiating a predetermined electromagnetic wave toward the heating body unit so that the melt is at the predetermined temperature.

The heating body unit of the present invention comprises: a heating container receiving the melt and forming a body for dissolving the melt.

The heating container of the present invention is characterized in that when the predetermined electromagnetic wave is selectively irradiated from the radiating unit, the predetermined heat is generated by interaction with the predetermined electromagnetic wave so that the melt is raised above the predetermined temperature.

The heating sensing unit of the present invention is selectively disposed at a predetermined point of the heating container, and selectively measures the temperature of the predetermined point to calculate the predetermined temperature information in real time.

The heating cover unit of the present invention comprises: a holding barrier selectively forming an outer wall covering the outside of the heating container part so that the temperature of the melt raised to the predetermined temperature is maintained; and a block barrier selectively forming an outer wall covering the holding barrier part, and preventing the predetermined heat generated from the heating container part from diffusing to the outside.

The heating cover unit of the present invention further comprises a slot barrier which selectively covers the outside of the block barrier and selectively forms a plurality of slots.

The radiating unit of the present invention comprises a plurality of generators selectively disposed in the plurality of slots of the slot barrier, and generating the predetermined electromagnetic wave.

The radiating unit of the present invention further comprises a plurality of guiders arranged on one side of the generating unit such that the predetermined angle of each of the plurality of generators is formed independently of each other, so that the predetermined electromagnetic wave passes through the plurality of slots and is irradiated to the heating container.

The radiating unit of the present invention is characterized in that the predetermined temperature information calculated from the heating sensing unit is selectively provided to the plurality of generators by interworking with the heating sensing unit.

The plurality of guiders of the present invention selectively receives the information of the predetermined point from the heating sensing unit and selectively adjusts the predetermined angle so that the predetermined electromagnetic wave reaches the predetermined point.

The furnace system for controlling of individual temperature through selectively radiating of electromagnetic waves according to the present invention having the above configuration provides the following effects.

First, by irradiating a predetermined electromagnetic wave to the inside of the heating body unit, it is possible to dissolve the melt above a predetermined temperature.

Second, it is possible to minimize heat loss by preventing a predetermined heat generated from the heating body unit from leaking to the outside through the heating cover unit.

Third, it is possible to selectively irradiate a predetermined electromagnetic wave according to temperature information by selectively sensing the temperature of a predetermined point inside the heating container unit.

Effects of the present invention are not limited to those mentioned above, and other effects not mentioned will be clearly understood by those skilled in the art from the following description.

### BRIEF DESCRIPTION OF DRAWINGS

FIG. 1 is a perspective view of the furnace system for controlling of individual temperature through selectively radiating of electromagnetic waves according to an embodiment of the present invention.

FIG. 2 is a front view of the furnace system for controlling of individual temperature through selectively radiating of electromagnetic waves according to an embodiment of the present invention.

FIG. 3 is a plan perspective view of the furnace system for controlling of individual temperature through selectively radiating of electromagnetic waves according to an embodiment of the present invention.

FIG. 4 is a plan view illustrating electromagnetic waves being irradiated to a heating container of the furnace system for controlling of individual temperature through selectively radiating of electromagnetic waves according to an embodiment of the present invention.

FIG. 5 is a cross-sectional view of a heating body unit, a heating cover unit, and a heating sensing unit of the furnace system for controlling of individual temperature through selectively radiating of electromagnetic waves according to an embodiment of the present invention.

FIG. 6 is a cross-sectional view illustrating that a predetermined electromagnetic wave of the furnace system for controlling of individual temperature through selectively radiating of electromagnetic waves according to an embodiment of the present invention.

FIG. 7 is a front view of a radiating unit of the furnace system for controlling of individual temperature through selectively radiating of electromagnetic waves according to an embodiment of the present invention.

FIG. 8 is a diagram illustrating controlling a predetermined electromagnetic wave of the radiating unit according to the temperature measured from the heating sensing unit of the furnace system for controlling of individual temperature through selectively radiating of electromagnetic waves according to an embodiment of the present invention.

### DETAILED DESCRIPTION OF THE INVENTION

The furnace system for controlling of individual temperature through selectively radiating of electromagnetic waves according to the present invention can have various changes and can have various embodiments and specific embodiments of the present invention are illustrated in the drawings and described in detail in the detailed description. However, this is not intended to limit the present invention to a specific embodiment, it should be understood to include all modifications, equivalents and substitutes included in the spirit and scope of the present invention.

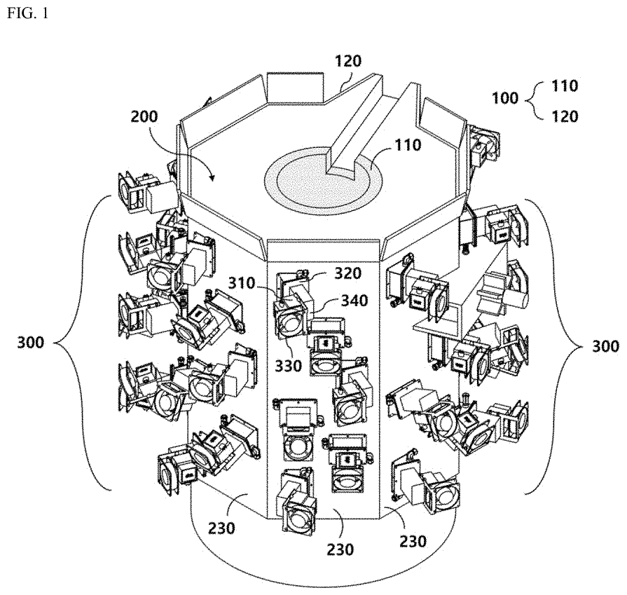

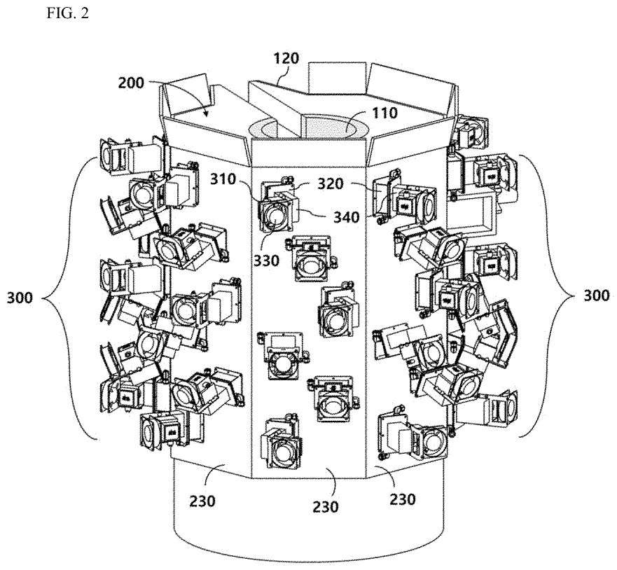

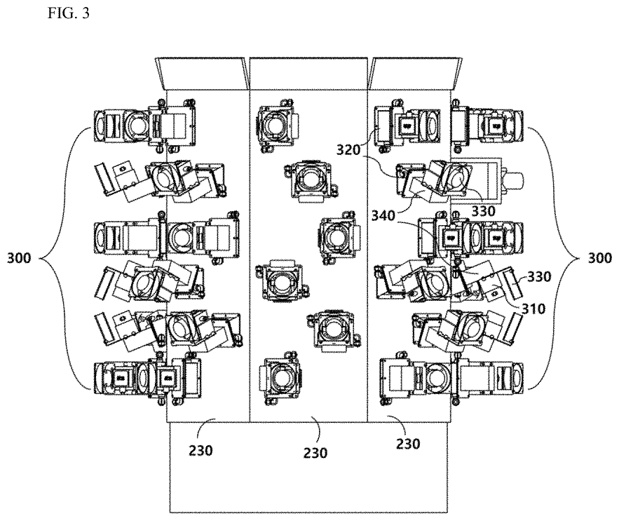

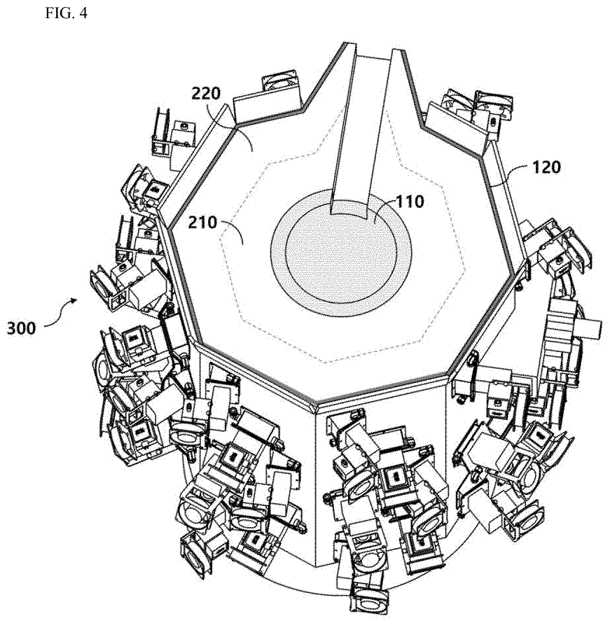

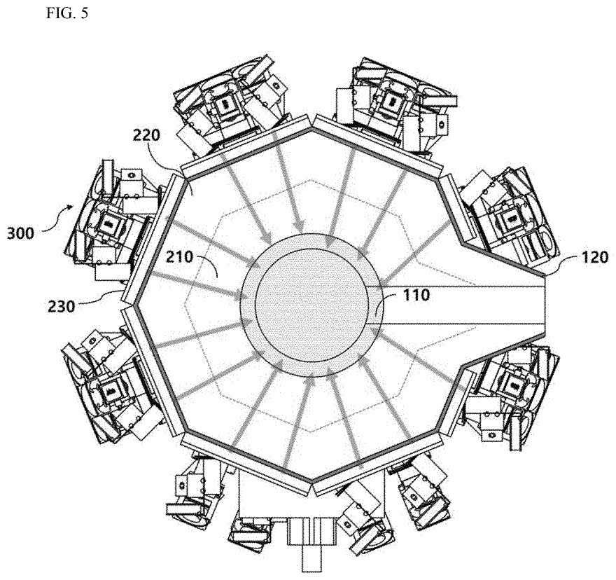

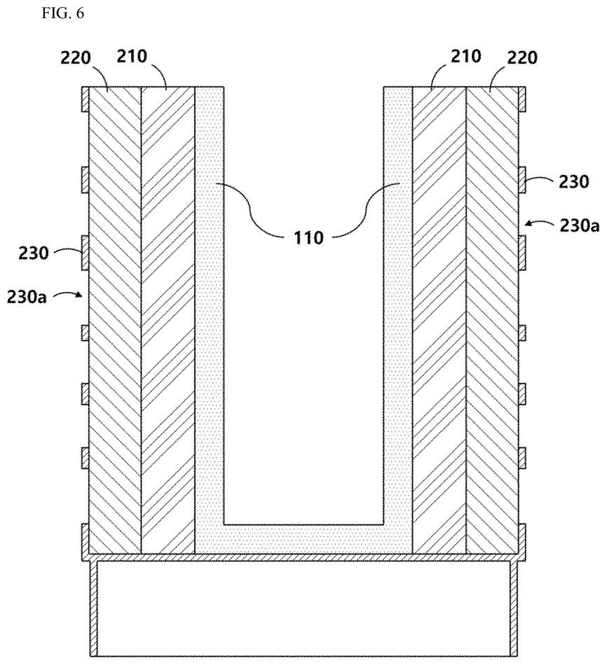

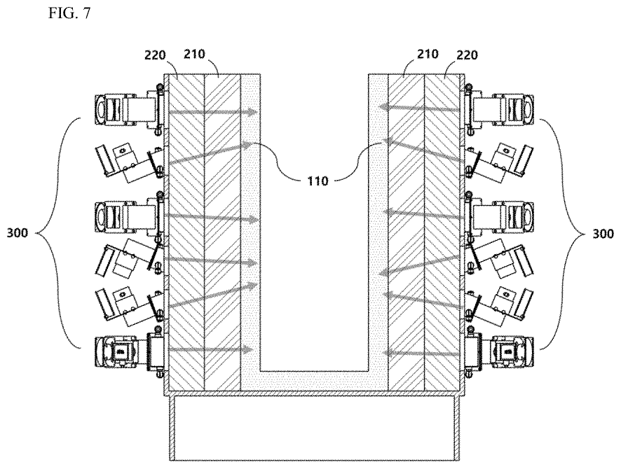

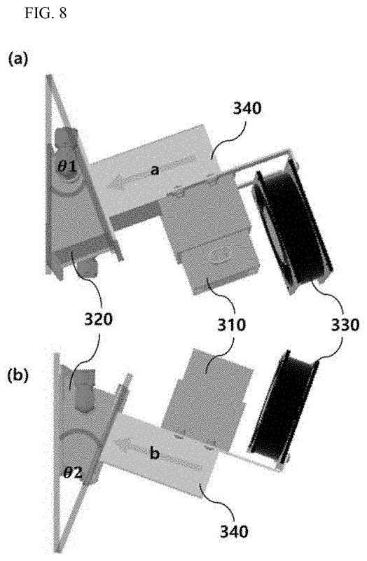

FIG. 1 is a perspective view of the furnace system for controlling of individual temperature through selectively radiating of electromagnetic waves according to an embodiment of the present invention. FIG. 2 is a front view of the furnace system for controlling of individual temperature through selectively radiating of electromagnetic waves according to an embodiment of the present invention. FIG. 3 is a plan perspective view of the furnace system for controlling of individual temperature through selectively radiating of electromagnetic waves according to an embodiment of the present invention. FIG. 4 is a plan view illustrating electromagnetic waves being irradiated to a heating container of the furnace system for controlling of individual temperature through selectively radiating of electromagnetic waves according to an embodiment of the present invention. FIG. 5 is a cross-sectional view of a heating body unit, a heating cover unit, and a heating sensing unit of the furnace system for controlling of individual temperature through selectively radiating of electromagnetic waves according to an embodiment of the present invention. FIG. 6 is a cross-sectional view illustrating that a predetermined electromagnetic wave of the furnace system for controlling of individual temperature through selectively radiating of electromagnetic waves according to an embodiment of the present invention. FIG. 7 is a front view of a radiating unit of the furnace system for controlling of individual temperature through selectively radiating of electromagnetic waves according to an embodiment of the present invention. FIG. 8 is a diagram illustrating controlling a predetermined electromagnetic wave of the radiating unit according to the temperature measured from the heating sensing unit of the furnace system for controlling of individual temperature through selectively radiating of electromagnetic waves according to an embodiment of the present invention. The furnace system for controlling of individual temperature through selectively radiating of electromagnetic waves according to the present invention is provided in a melting furnace for melting various types of ferro alloy. The furnace system for controlling of individual temperature through selectively radiating of electromagnetic waves selectively irradiates predetermined electromagnetic waves inside the melting furnace, heat the inside of the melting furnace, heat the ferro alloys, produce and cast it as a melt.

Here, the ferro alloy (ferro silicon or ferro manganese) is a ferro alloy used for manufacturing steel or cast iron, and the ferro silicon is used as a deoxidizer and a reducing agent, and is used as a graphitization accelerator in carbon steel.

The ferro alloy heated in the melting furnace is melted and produced as a melt, and the resulting melt is transferred to a casting mold and cast to be manufactured in a size or shape of a certain unit.

As shown in FIG. 1, the furnace system for controlling of individual temperature through selectively radiating of electromagnetic waves according to the present invention irradiates a predetermined electromagnetic wave toward the inside of the melting furnace to generate a melt, heats melting furnace and then the temperature is heated to a temperature above the melting point of the ferro alloy, so that a melt can be formed. At this time, by sensing the temperature information inside the melting furnace, a predetermined electromagnetic wave is controlled according to the temperature.

The furnace system for controlling of individual temperature through selectively radiating of electromagnetic waves according to the present invention, as shown in FIGS. 1 and 2, comprises a heating body unit 100, a heating cover unit 200, and a radiating unit 300, and a heating sensing unit 400.

As shown in FIG. 1, the heating body unit 100, when the melt is added, is configured to heat the melt to a predetermined temperature.

When the steel auxiliary material such as ferro alloy is input, the heating body unit 100 heats them to a predetermined temperature in order to melt them.

The predetermined temperature referred to herein is a melting point or a temperature above the melting point of the melt, and may be defined as a temperature for melting the melt.

In addition, the heating body unit 100 is configured to maintain a high temperature in order to melt the melt, and its properties are preferably made of a material corresponding to heat resistance and a refractory material. Here, the heat-resistant or refractory material is an ultra-high-temperature heat-resistant material that can withstand a high temperature of several hundred to several thousand degrees (° C.), several seconds to several thousand hours, so the heat-resistant or refractory material can be typically a type of a metal or ceramic material.

The heating body unit 100 of the furnace system for controlling of individual temperature through selectively radiating of electromagnetic waves according to the present invention, as shown in FIG. 3, comprises a heating container 110 and a heating sealer 120.

As shown in FIGS. 1 and 3, the heating container unit 110 receives the melt and forms a body to dissolve the melt.

The heating container 110 forms a predetermined space to accommodate the melt therein, so that the melt can be dissolved.

When a predetermined electromagnetic wave is selectively irradiated from the radiating unit 300, the heating container 110 generates predetermined heat by interaction with the predetermined electromagnetic wave, and through the generated predetermined heat, raises the temperature of the melt above a predetermined temperature.

Preferably, the heating container 110 is preferably a silicon carbide (SiC) compound in which silicon and carbon are combined in a 1:1 ratio. Utilizing the properties of silicon carbide that have already been commercialized, the heating container 110 can generate a predetermined heat by itself when a predetermined electromagnetic wave is irradiated, so a detailed mechanism thereof can be omitted.

In addition, as the predetermined heat generated in the heating container 110 is thermally conducted to the melt, and then the melt is heated to a predetermined temperature or higher to be dissolved.

As shown in FIGS. 3 and 4, the heating sealer 120 is provided on the upper edge of the heating body unit 100, seals the edge of the heating body unit 100 and prevent the predetermined electromagnetic wave from being emitted to the outside.

The heating sealer 120 is to prevent the predetermined electromagnetic wave from leaking out when the predetermined electromagnetic wave is irradiated after the entrance of the heating body unit 100 is closed.

In addition, the heating sealer 120 is preferably made of a material corresponding to heat resistance and refractory material. Here, the heat-resistant or refractory material can be defined as an ultra-high-temperature heat-resistant material that can withstand high temperatures for hundreds to thousands of degrees (° C.), several seconds to thousands of hours.

As shown in FIGS. 1 and 2, the heating sensing unit 400 is provided to the heating body unit 100, and selectively measures the internal temperature of the heating body unit 100 to calculate predetermined temperature.

The heating sensing unit 400 is selectively disposed at a predetermined point of the heating container 110, and is configured to selectively measure the temperature at the predetermined point to calculate predetermined temperature in real time.

The predetermined point referred to herein is at least one or more points, and may be determined differently depending on the height of the heating container 110.

For example, the heating container unit 110 is divided into an upper layer, a middle layer, and a lower layer, and the heating sensing unit 400 is fixedly attached to each position. Each of the temperature in the upper layer, the temperature in the middle layer, the temperature in the lower layer of the heating container 110 is measured. In addition, it is preferable that there is no limit to the location, number, and size of the predetermined points.

In addition, the reason for measuring the respective temperature of the predetermined point in the heating sensing unit 400 is to individually and independently control the temperature at the predetermined point according to the predetermined temperature.

For example, as shown in FIG. 5, the heating sensing unit 400 allows the temperature information measured in the upper layer to be calculated as 1500° C. when the upper layer A is arbitrarily selected from the predetermined points.

The temperature information calculated by the heating sensing unit 400 is transmitted to the radiating unit 300 through an external server, and the radiating unit 300 receives the irradiation intensity, irradiation angle, irradiation time of a predetermined electromagnetic wave based on the temperature information.

The heating cover unit 200 is configured to selectively cover the heating body unit 100 to prevent a predetermined heat from being diffused to the outside so that the melt maintains a predetermined temperature.

In addition, the heating sensing unit 400 may utilize commercially available vision sensors, infrared sensors, ultrasonic sensors, position sensors, camera sensors, temperature sensors, and the like, so detailed mechanisms thereof can be omitted.

As shown in FIGS. 1 and 3, the heating cover unit 200 prevents the heat generated in the heating container 110 by a predetermined electromagnetic wave from being lost so that the melt can be melted.

In addition, the heating cover unit 200 forms an outer wall on the outside of the heating container unit 110 in the height direction, and is disposed to surround the heating container 110, so that the generated predetermined heat does not escape to the outside. By maintaining the internal temperature of the heating container 110, the thermal loss of the melt can be minimized, and the convection phenomenon can occur inside the heating container so that the melt can be uniformly dissolved.

The heating cover unit 200 is also preferably made of a material having heat resistance and fire resistance, for example, a fire resistant block or a heat insulating block.

The heating cover unit 200 of furnace system for controlling of individual temperature through selectively radiating of electromagnetic waves according to the present invention, as shown in FIG. 5, comprises a holding barrier 210, a block barrier 220 and a slot barrier 230.

First, the holding barrier 210, as shown in FIG. 5, selectively forms an outer wall covering the outside of the heating container 110, and maintains the temperature of the melt raised to a predetermined temperature.

The block barrier 220, as shown in FIG. 5, selectively forms an outer wall covering the holding barrier 210, and prevents the predetermined heat generated from the heating container 110 from being diffused to the outside.

The slot barrier 230, as shown in FIG. 2, selectively covers the outside of the block barrier 220, and selectively forms a plurality of slots 230.

As shown in FIG. 4, the plurality of slots 230a of the slot barrier 230 are for irradiating a predetermined electromagnetic wave generated from the radiating unit 300 inward toward the heating container 110. That is, the plurality of slots 230a exist to allow a predetermined electromagnetic wave to be radiated only to the inside.

As shown in FIG. 6, the part except for the plurality of slots 230a of the slot barrier 230 partially covers the block barrier 220 and prevent the predetermined electromagnetic wave irradiated inward from being irradiated outward caused by interference or diffraction.

Each of the slots of the slot barrier 230 is sealed by the radiating unit 300 to prevent a predetermined electromagnetic wave from leaking to the outside, and at the same time to allow the predetermined electromagnetic wave to be irradiated inwardly.

As shown in FIG. 6, the radiating unit 300 is selectively provided to to the heating cover unit 200 and selectively irradiates the predetermined electromagnetic wave to the heating body unit 100 so that the melt is at a predetermined temperature.

The radiating unit 300 covers the plurality of slots 230a, and allows a predetermined electromagnetic wave to be irradiated only to the inside.

The radiating unit 300 of the furnace system for controlling of individual temperature through selectively radiating of electromagnetic waves according to the present invention, as shown in FIG. 7, comprises a generator 310, guiding a guider 320, a cooler 330 and a bridge 340.

The generator 310, as shown in FIG. 7, is selectively disposed in the plurality of slots 230a of the slot barrier 230 to generate predetermined electromagnetic waves.

The generator 310 may generate a predetermined electromagnetic wave by using the same or similar configuration and principle as that of a commercially available magnetron, and a detailed mechanism thereof can be omitted.

As shown in FIG. 7, the guider 320 is disposed on one side of the plurality of generator 310, and allows the generator 310 to independently form a predetermined angle each other. That is, the angle of the generator 310 can be controlled according to the predetermined angle of the guider 320.

In addition, the guider 320 has a plurality of components such that a predetermined electromagnetic wave passes through the plurality of slots 230a and is irradiated to the heating container 110.

The guider 320 transmit a predetermined electromagnetic wave generated from the generator 310 to the heating body unit 100.

The plurality of guider 320 are separately installed in each of the plurality of generators 310, and allow each of the generators 310 to form predetermined angles independently of each other.

In addition, the guider 320 has one side and the other side formed at different angles so that the generator 310 can be formed at a predetermined angle.

As shown in FIG. 7, for example, the predetermined angle is formed as θ 1 as shown in FIG. 7(a), and a predetermined electromagnetic wave may be irradiated in the a direction. In addition, when the predetermined angle is formed as θ 2 as shown in FIG. 7(b), a predetermined electromagnetic wave may be irradiated in the b direction. That is, it is possible to selectively control the direction in which a predetermined electromagnetic wave is irradiated according to a predetermined angle.

In addition, the plurality of guiders 320 are disposed to cross each other, so that predetermined electromagnetic waves generated from the plurality of generators 310 are selectively irradiated so as not to conflict or overlap each other.

For example, as shown in FIG. 6, when a predetermined electromagnetic wave generated from the generator 310 that is radially disposed on the outside of the heating body unit 100 is irradiated toward the heating body unit 100, collision between predetermined electromagnetic waves may occur.

When the electromagnetic waves collide each other, the generated collision energy may cause overall damage to devices such as the heating body unit 100, the heating cover unit 200 or the radiating unit 300, so the function of the furnace may be lost by the collision of the electromagnetic waves.

Therefore, it is preferable to arrange the plurality of generating units 310 to cross each other in order not to overlap the predetermined electromagnetic waves irradiated.

That is, a predetermined electromagnetic wave does not overlap according to the angle and arrangement relationship of the radiating unit 300, and the heating container unit 110 may generate heat. In addition, the angle of the radiating unit 300 is selectively adjusted so that the melt is uniformly dissolved in the heating container 110.

As shown in FIG. 8, the radiating unit 300 interworks with the heating sensing unit 400 and selectively provides the predetermined temperature calculated from the heating sensing unit 400 to the plurality of generators 310.

At this time, the predetermined temperature measured at the predetermined point is selectively provided to each of the plurality of generators 310. It is preferable that the predetermined temperature sensed in the upper layer among the predetermined points selected from among the plurality of generators 310 is transferred to the generator 310 disposed on the upper portion of the radiating unit 300.

According to the interlocking of the radiating unit 300 and the heating sensing unit 400, the plurality of guiders 320 selectively receive the information of the predetermined point from the heating sensing unit 400, and the predetermined angle is determined in advance to allow the predetermined electromagnetic wave to reach the predetermined point.

For example, as described above, the predetermined temperature sensed in the upper layer among the predetermined points is transmitted to the generator 310 disposed above the radiating unit 300 among the plurality of generating units 310. The predetermined angle of the guider 320 provided to the generating unit 310 disposed thereon is selectively set so that the predetermined electromagnetic wave reaches the upper layer of the predetermined point.

Through the mutual interworking of the radiating unit 300 and the heating sensing unit 400, it is possible to control the intensity and irradiation angle of a predetermined electromagnetic wave according to the temperature information inside the heating container 110, so the predetermined electromagnetic wave is uniformly irradiated inside the heating container 110, and then the heating container 110 can be heated to a target temperature. Accordingly, the convection phenomenon of the melt existing inside the heating container 110 can be induced, and the melt can be uniformly melted, so that the effect of resolving the imbalance of the temperature difference according to the location occurs.

In the case of the cooler 330, as shown in FIG. 7, it is selectively disposed on the other side of the generator 310 to cool a predetermined heat generated from the generator 310 when a predetermined electromagnetic wave is generated.

For example, when the generator 310 generates a predetermined electromagnetic wave, heat is generated, and if the generated heat continues, the generator 310 may fail.

Accordingly, the cooler 330 serves to cool the heat of the generator 310 in order to prevent failure or damage of the generator 310.

In the case of the bridge 340, as shown in FIG. 7, one side is provided to the guider 320 and the other side is provided to the generator 310 to form the guider 320 and the generator 310.

The bridge 340 is formed to protrude from the guider 320 to interconnect the generators 310. With selectively adjusting the protrusion angle of the bridge 340, a predetermined electromagnetic wave can be controlled so as not to collide.

The scope of the present invention is determined by the matters described in the claims, and parentheses used in the claims are not described for selective limitation, but are used for clear components, and descriptions in parentheses are also interpreted as essential components.

What is claimed is:

1. A furnace system for controlling of individual temperature through selectively radiating of electromagnetic waves, the furnace system comprises:
A heating body unit for heating melt to a predetermined temperature when the melt is added;
A heating sensing unit provided in the heating body unit to selectively measure the internal temperature of the heating body unit to calculate a preset temperature information;
A heating cover unit that selectively covers the heating body unit and prevent a predetermined heat from being diffused to the outside so that the melt maintains the predetermined temperature; and
A radiating unit selectively provided to the heating cover unit, receiving the predetermined temperature information from the heating sensing unit, and selectively irradiating a predetermined electromagnetic wave toward the heating body unit so that the melt is at the predetermined temperature.

2. The furnace system according to claim 1, wherein the heating body unit comprises a heating container receiving the melt and forming a body for dissolving the melt.

3. The furnace system according to claim 2, wherein the heating container is characterized in that when the predetermined electromagnetic wave is selectively irradiated from the radiating unit, the predetermined heat is generated by interaction with the predetermined electromagnetic wave so that the melt is raised above the predetermined temperature.

4. The furnace system according to claim 3, wherein the heating sensing unit is selectively disposed at a predetermined point of the heating container, and selectively measures the temperature of the predetermined point to calculate the predetermined temperature information in real time.

5. The furnace system according to claim 4, wherein the heating cover unit comprises:
a holding barrier selectively forming an outer wall covering the outside of the heating container part so that the temperature of the melt raised to the predetermined temperature is maintained; and
a block barrier selectively forming an outer wall covering the holding barrier part, and preventing the predetermined heat generated from the heating container part from diffusing to the outside.

6. The furnace system according to claim 5, wherein the heating cover unit further comprises a slot barrier which selectively covers the outside of the block barrier and selectively forms a plurality of slots.

7. The furnace system according to claim 6, wherein the radiating unit comprises a plurality of generators selectively disposed in the plurality of slots of the slot barrier, and generating the predetermined electromagnetic wave.

8. The furnace system according to claim 7, wherein the radiating unit further comprises a plurality of guiders arranged on one side of the generating unit such that the predetermined angle of each of the plurality of generators is formed independently of each other, so that the predetermined electromagnetic wave passes through the plurality of slots and is irradiated to the heating container.

9. The furnace system according to claim 8, wherein the radiating unit is characterized in that the predetermined temperature information calculated from the heating sensing unit is selectively provided to the plurality of generators by interworking with the heating sensing unit.

10. The furnace system according to claim 9, wherein the plurality of guiders selectively receives the information of the predetermined point from the heating sensing unit and selectively adjusts the predetermined angle so that the predetermined electromagnetic wave reaches the predetermined point.
